(19) United States
(12) Patent Application Publication
(10) Pub. No.: US 2026/0270370 A1
(43) Pub. Date: Sep. 10, 2026

(54) IMMERSIVE BACKGROUNDS FOR VIDEOCONFERENCING

(71) Applicant: MICROSOFT TECHNOLOGY LICENSING, LLC, Redmond, WA (US)

(72) Inventors: Andréa BRITTO MATTOS LIMA, Sao Paulo (BR); Spencer G FOWERS, Duvall, WA (US); Thiago VALLIN SPINA, Campinas (BR)

(21) Appl. No.: 19/069,689

(22) Filed: Mar. 4, 2025

(51) Int. Cl. H04N 7/15; G06T 5/77; G06T 7/11; G06T 7/50

(52) U.S. Cl. CPC H04N 7/157; G06T 5/77; G06T 7/11; G06T 7/50; G06T 2207/20081

(57) ABSTRACT

Immersive backgrounds for videoconferencing are created by processing a two-dimensional (2D) image into several layers that have depth and shift based on the changing perspective of an observer. The viewpoint orientation of the observer is tracked, and the layers of the image are moved according to the parallax effect to create an appearance of depth. When used as a background for a videoconference, this creates a more immersive experience because the background behind a videoconference participant appears to be three-dimensional rather than static. A 2D image is converted into an immersive background by application of multiple image-processing techniques including image segmentation, depth estimation, and image completion.

### BACKGROUND

Videoconferencing has become an essential tool for communication, especially in remote work environments. Many people choose to use a background when videoconferencing so that the actual room behind them is not shown to other videoconference participants. This may be done for privacy, to present a more professional appearance, or for other reasons. The background may be a photograph or other image. However, these types of static backgrounds can be unengaging and lack depth.

While videoconferencing can be more engaging and support a stronger sense of presence than audio-only communication, it still lacks the sense of connection achieved by in-person interaction. The appearance of a person's face in front of a static background can create a sense of unreality or artificiality. Thus, while use of a static background may help with privacy, it can also detract from the videoconferencing experience.

It would be desirable to create more immersive and dynamic backgrounds to enhance the videoconferencing experience and increase a sense of presence. It is with respect to these and other considerations that the disclosure made herein is presented.

### SUMMARY

This disclosure relates to techniques for creating and using immersive backgrounds for videoconferencing. The system allows users to select a two-dimensional (2D) image as a background, which is then processed through layer segmentation, image completion, and depth estimation. These may be performed using artificial intelligence (AI) tools. Each layer can be further processed to perform image completion such as image inpainting and outpainting, resulting in a 2.5D image composed of stacked layers. The image completion may also be performed by AI tools including diffusion models.

During a videoconference, the system tracks an observer's viewpoint orientation in real-time with techniques such as AI-based eye/head tracking technology. The immersive background is dynamically adjusted based on changes in the viewpoint orientation of the observer to simulate the parallax effect and create the illusion of a 3D background. The system can include a user interface (UI) for selecting a 2D image, an image processing module for processing the image, a viewpoint orientation tracking module for eye movement tracking, and a rendering module for adjusting the background. This creation of dynamic 3D effects from 2D images provides a more natural and engaging videoconferencing experience because of the interactive background adjustments. The techniques of this disclosure are much less computationally and data intensive than creating a full 3D model of the background image. Thus, using a 2.5D image as an immersive background provides technical benefits include reduced processor usage, lower storage requirements, and decreased consumption of network bandwidth as compared to a full 3D background.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 shows an illustrative videoconference UI.

FIG. 2 shows an illustrative 2D image that can be used as a background.

FIG. 3 shows identification of objects in a 2D image.

FIG. 4 shows a plurality of layers created from a 2D image.

FIG. 5 shows the results of inpainting on the plurality of layers.

FIG. 6 shows the results of outpainting on the plurality of layers.

FIG. 7 shows viewpoint orientation tracking of an observer of a videoconference UI.

FIG. 8 shows the relative positioning of layers of an immersive background.

FIG. 9 shows a change in the relative position of layers of the immersive background responsive to a change in the viewpoint orientation of an observer.

FIG. 10 is a flow diagram of an example method for generating and using an immersive background in a videoconference.

FIG. 11 is a computer architecture diagram showing an illustrative computer hardware and software architecture for a computing system capable of implementing aspects of the techniques and technologies presented herein.

FIG. 12 is a diagram illustrating a distributed computing environment capable of implementing aspects of the techniques and technologies presented herein.

### DETAILED DESCRIPTION

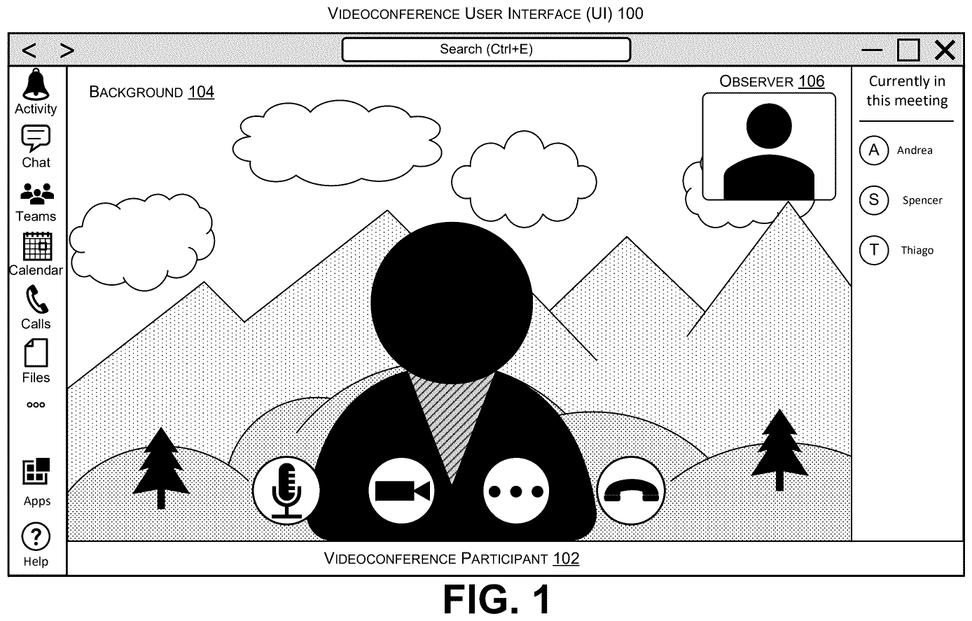

FIG. 1 illustrates an example of a videoconference UI 100. The videoconference UI 100 shows an image of a videoconference participant 102. The videoconference participant 102 is a person who is not viewing the videoconference UI 100. Typically, but not necessarily, the videoconference participant 102 is a person at another location accessing the videoconference from a different computing device. A camera captures video of the videoconference participant 102 and this video image is included in the videoconference UI 100. Any portion of the videoconference participant 102 may be shown but typically the head and upper torso are visible.

There is also a background 104 behind the image of the videoconference participant 102. The background 104 is an image displayed instead of the actual scene behind the videoconference participant 102. The actual scene behind the videoconference participant 102 is captured by the camera but removed in real-time by known background removal techniques. Thus, the background 104 shown in the videoconference UI 100 is not captured in real-time by the camera that provides the video of the videoconference participant 102. Generally, the videoconference participant 102 himself or herself selects the background 104; however, it may also be provided by videoconferencing software, an administrator, or other source.

This background 104 in the videoconference UI 100 of this disclosure is an immersive background. Immersive backgrounds are backgrounds that change in response to changes in the viewpoint orientation of the observer 106. The background 104 includes a plurality of layers created from a 2D image by layer segmentation, depth estimation, and image completion. Each layer may be itself a 2D image. The relative positioning of the layers with respect to each other shifts based on the parallax effect in response to a change in viewpoint orientation of an observer of the UI creating what is referred to as a 2.5D image. Thus, as the observer 106 changes the position or his or her head or changes where he or she is looking, the background 104 changes. The background 104 is adjusted based on the change in viewpoint orientation creating a parallax effect that provides the illusion of depth to the background 104 and results in a more immersive experience than a static background.

The videoconference UI 100 may also include any number and type of other UI elements for users to interact with and manage the videoconference. These can include, without limitation, UI elements to turn audio and video on or off, end the videoconference, participate in a text chat, view a list of participants in the videoconference, etc.

The videoconference UI 100 may also, but does not necessarily, include an image of an observer 106 of the videoconference. The observer 106 of the videoconference is a person who is viewing the videoconference UI 100. This can be referred to as a “self-view” of the observer 106. If the image, which may be a video image, of the observer 106 is included in the videoconference (whether self-view is turned on or not) the observer 106 is then also a participant in the videoconference. However, it is also possible for the observer 106 to be a person who is only viewing the videoconference UI 100 without providing video, audio, text chat, or any other contribution to the videoconference. A camera that captures the image of the observer may also be used for detecting viewpoint orientation of the observer. However, other hardware may additionally or alternatively be used.

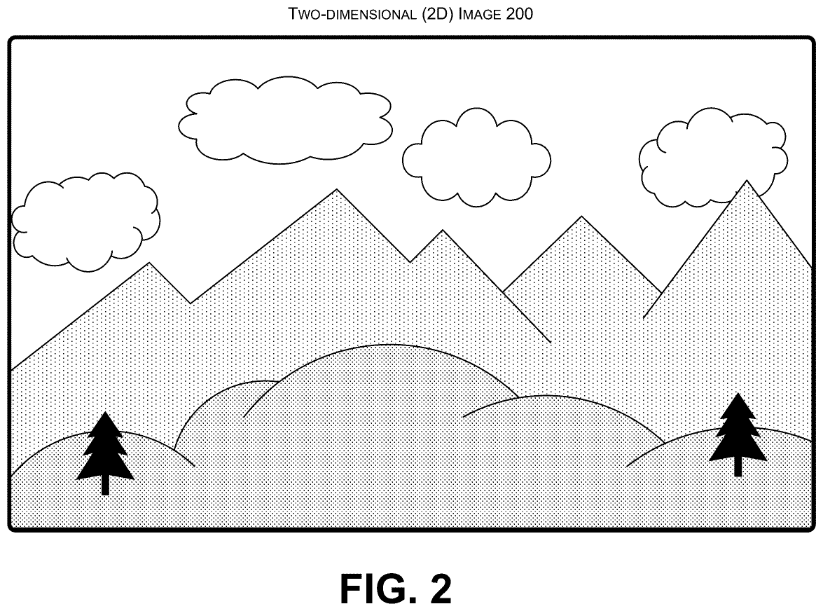

FIG. 2 illustrates a 2D image 200 that can be used as a background in a videoconference. In this example, the image shows mountains and clouds with low hills and trees. The 2D image 200 may come from any source such as a photograph, a computer-generated image (including AI generated), a hand-drawn image that is scanned, etc. The 2D image 200 is an electronic image and may be in any format capable of being interpreted by a computer. In some implementations, a system may include a user interface for a user to select the 2D image 200 that will be used as a background. The user making this selection is typically, but not necessarily, the videoconference participant 102 who will be shown in front of that background. The 2D image 200 may show any type of content such as scenery, buildings, people, etc. In some implementations, the 2D image can be selected from a datastore of images such as those provided by videoconferencing software. This 2D image 200 is then processes as described below to create a 2.5D image that is used as an immersive background. A 2.5D image is a visual representation that uses a plurality of layers arranged at different depth values to create the illusion of three-dimensionality while maintaining fundamentally 2D graphics on each layer.

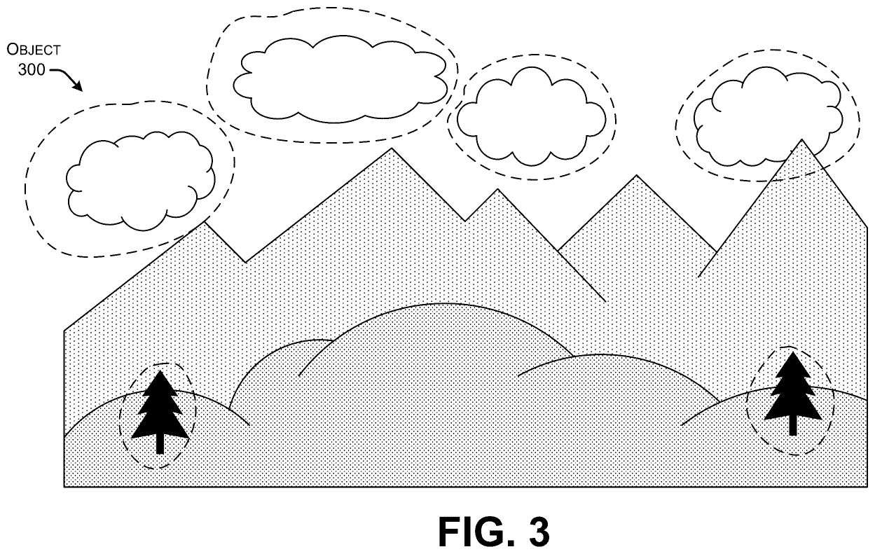

FIG. 3 illustrates identification of objects 300 in the 2D image 200 from FIG. 2. Here, some of the possible objects 300 in the 2D image 200 are shown circled by dotted lines. These are clouds and trees. The mountains and hills are also identified as one or more objects each but this is not shown for visual simplicity. During image segmentation every pixel in the 2D image 200 may be assigned to a specific object or area. Thus, the 2D image 200 is entirely segmented into a number of discrete objects.

Any existing or later developed technique for object identification and image segmentation may be used to identify objects in the 2D image 200. Object identification is a machine vision technique that involves detecting objects within an image. Image segmentation partitions an image into multiple segments or regions, each corresponding to different objects or areas of interest, typically by assigning a pixel-wise mask to each object or area. Techniques for identifying objects and image segmentation may us machine learning or AI. One suitable technique is that provided by the Segment Anything Model (SAM) described in Alexander Kirillov et al., Segment Anything, arXiv: 2304.02643[cs.CV] (Apr. 5, 2023). SAM has a promptable design that allows it to adapt to various segmentation tasks without additional training, achieving zero-shot performance that often matches or exceeds fully supervised models. Trained on the extensive SA-1B dataset, which includes over 1 billion masks across 11 million images, SAM provides versatility and efficiency.

Other image segmentation techniques in computer vision include thresholding, which converts an image into a binary format based on a threshold value, and region-based segmentation, which partitions an image into regions with similar characteristics like intensity or texture. Additionally, edge-based segmentation detects edges to identify boundaries between regions, while clustering methods like k-means group pixels based on features such as color or intensity. Deep learning-based segmentation, using models like Convolutional Neural Networks (CNNs) and Fully Convolutional Networks (FCNs), performs pixel-wise classification for more accurate results. Graph-based segmentation models the image as a graph and partitions it by minimizing a cost function. These techniques can be combined with domain-specific knowledge to effectively address various segmentation challenges.

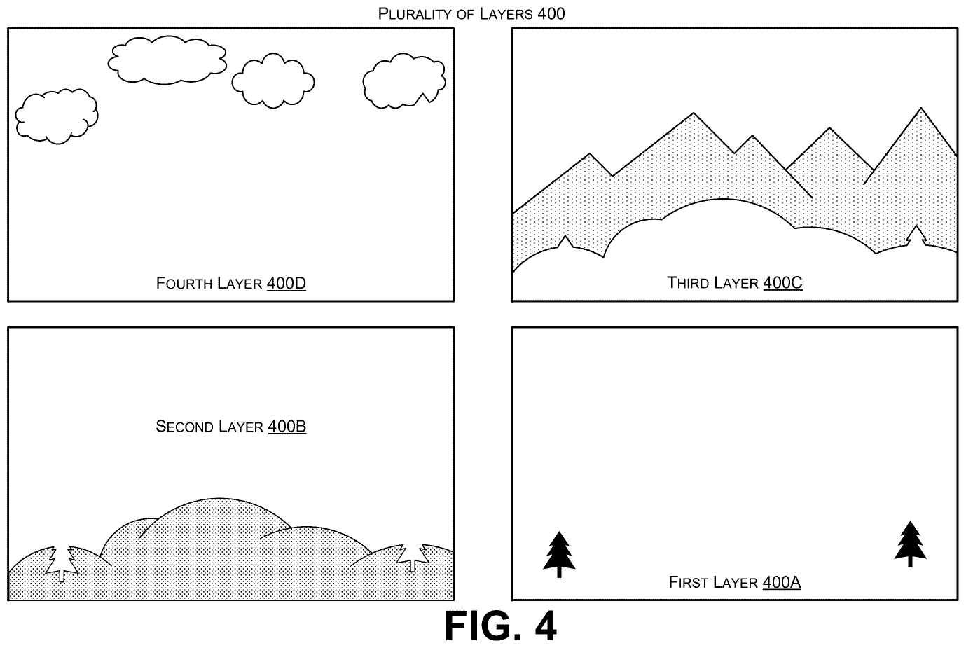

FIG. 4 illustrates separation of the 2D image 200 into a plurality of layers 400. Each layer 400 includes one or more of the objects 300 identified by layer segmentation that are determined to have a same depth based on depth estimation. Depths are determined for the objects 300 using a depth estimation algorithm. Any existing or later developed technique for determining the depths of objects 300 in a 2D image 200 may be used. For example, depth may be determined by using a monocular depth estimation algorithm. A monocular depth estimation algorithm is a computational method designed to predict the depth of objects within a scene using a single 2D image.

One suitable technique for determining depth is provided by the Depth Anything described in Lihe Yang et al., Depth Anything: Unleashing the Power of Large-Scale Unlabeled Data, arXiv: 2401.10891[cs.CV] (Jan. 19, 2024). Depth Anything is a foundation model for monocular depth estimation. It leverages a combination of labeled and unlabeled data to achieve robust performance. The model is trained on a vast dataset, including 1.5 million labeled images and over 62 million unlabeled images. Depth Anything uses a transformer-based architecture, which allows it to capture long-range dependencies and contextual information within images. The model supports multiple scales, from small to giant, providing flexibility in terms of computational resources and accuracy.

Another suitable technique for depth estimation is Marigold described in Bingxin Ke et al., Repurposing Diffusion-Based Image Generators for Monocular Depth Estimation, arXiv: 2312.02145[cs.CV] (Feb. 4, 2024). Marigold is a diffusion-based model for monocular depth estimation. Marigold repurposes diffusion-based image generators, such as Stable Diffusion, for depth estimation tasks. The core principle of Marigold is to leverage the rich visual knowledge stored in modern generative image models. The model is fine-tuned with synthetic data, allowing it to perform zero-shot transfer to unseen data. Marigold's approach involves using a latent diffusion model (LDM) for depth estimation, which injects depth observations as test-time guidance via an optimization scheme that runs in tandem with the iterative inference of denoising diffusion.

Other examples include MiDaS (Mixed Depth and Scale), DPT (Dense Prediction Transformer), and Monodepth2. MiDaS employs deep learning techniques to ensure robustness across diverse datasets. DPT uses transformers to achieve high accuracy in depth estimation. Monodepth2 is an unsupervised learning algorithm that is trained on stereo image pairs and applies the learned model to monocular images.

Determination of depth allows for the creation of layers 400 from the objects identified in the segmented 2D image 200. In one implementation, all objects determined to have the same or similar depth are grouped into a same layer. Similarity of depth may be determined in any number of ways such as by grouping or clustering techniques. Depth values may be assigned for objects and portions of the 2D image and then grouped or clustered into a discrete number of layers 400 based on depth. The plurality of layers 400 includes at least two layers 400 but there is no upper limit on the number of layers. The depth for a layer 400 is based on the depths of the objects included in that layer 400. If a layer 400 contains multiple objects 300 with different depths, there are multiple ways to assign a single depth to that layer 400. For example, the depth of the layer 400 could be the average or median of the depths of the objects 300 within the layer 400. Alternatively, the depth of the layer 400 may be set to that of the object 300 with the maximum or minimum depth out of all the objects 300 in that layer 400. Other techniques are also possible.

In FIG. 4, four layers 400 are created from the 2D image 200. A first layer 400A includes trees that are in the foreground. A second layer 400B has the low hills that are behind the trees. A third layer 400C contains the mountains. A fourth layer 400D includes the clouds behind the mountains. Depth for each of the layers 400A-400D may be represented by a depth value. This is a numerical value that indicates how far the layer 400 is from the perspective of a viewer. A depth value contains more information than a z-order which simply indicates the order of the layers. In one implementation, a higher depth value indicates greater distance. For example, a layer with a depth value of 10 is ten times farther away than a layer with a depth value of 1. For example, the first layer 400A may have a depth value of 3, the second layer 400B a depth value of 5, the third layer 400C a depth value of 12, and the fourth layer 400D a depth value of 30.

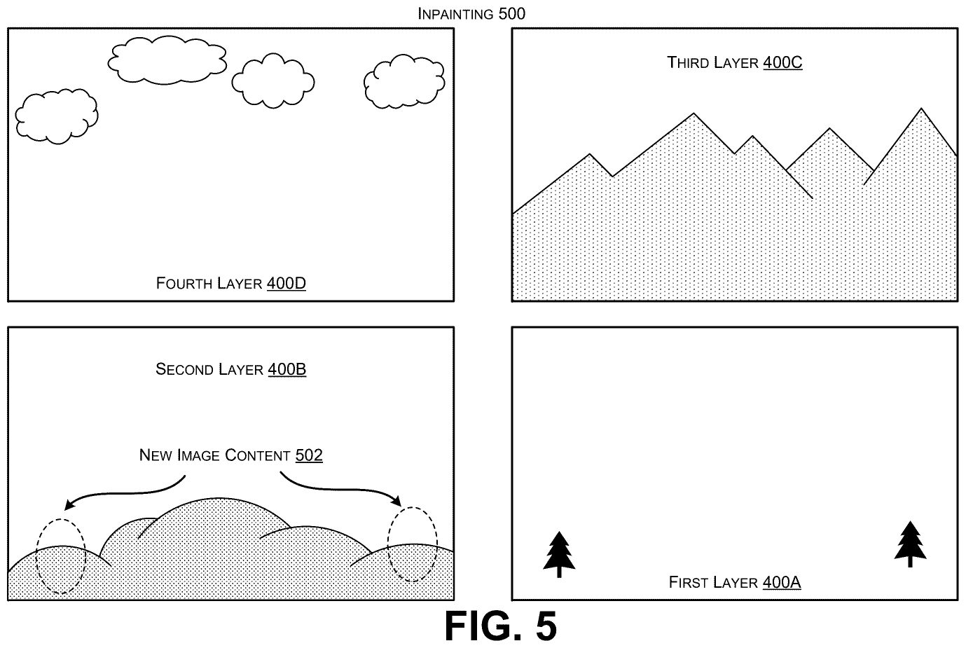

FIG. 5 illustrates the results of inpainting 500 performed on the layers 400. Following layer segmentation, portions of a layer that are behind an object in a more forward layer may appear as missing image content. Returning to FIG. 4, there are portions of the second layer 400B “missing” following removal of the trees in the first layer 400A. Similarly, the “bottom” of the mountains in the third layer 400C and a portion of one cloud in the fourth layer 400D also appear missing.

Inpainting 500, which is a type of image completion, is used to fill in these portions of the layers 400. Inpainting is a technique used in image processing to fill in missing or damaged parts of an image. It involves using algorithms to predict and reconstruct the missing regions based on the surrounding pixel information, ensuring the completed image looks seamless and natural. The results of inpainting 500, the added portions of the layers 400, are referred to as new image content 502. This is shown in the second layer 400B by creation of images of the hills behind the trees. New image content 502 is also added to the third layer 400C and the fourth layer 400D but not specifically labeled for simplicity. The new image content 502 was not included in the 2D image 200 but is generated to complete the image content available in a given layer 400. Following inpainting 500, the layers 400 appear “complete,” that is any apparently missing portions are added so that each layer 400 can be shown without gaps.

Any current or later developed technique for inpainting 500 may be used. For example, exemplar-based inpainting, which fills missing parts by copying similar patches from surrounding areas may be used. This can be effective for small, textured regions but may struggle with larger gaps. Many suitable techniques use machine learning or AI. For example, convolutional neural networks (CNNs) which predict missing pixel values based on surrounding context and generative adversarial networks (GANs) consisting of a generator and discriminator to produce realistic inpainted images may both be used for inpainting. Other techniques include the use of an encoder-decoder architecture to predict the missing regions. The encoder compresses the image into a latent space, and the decoder reconstructs the image, filling in the gaps. Specific algorithms include, but are not limited to, U-Net, which uses a contracting path to capture context and a symmetric expanding path to enable precise localization and DeepFill v2, which uses a two-stage generative approach to fill large and multiple areas without boundary artifacts or distortions.

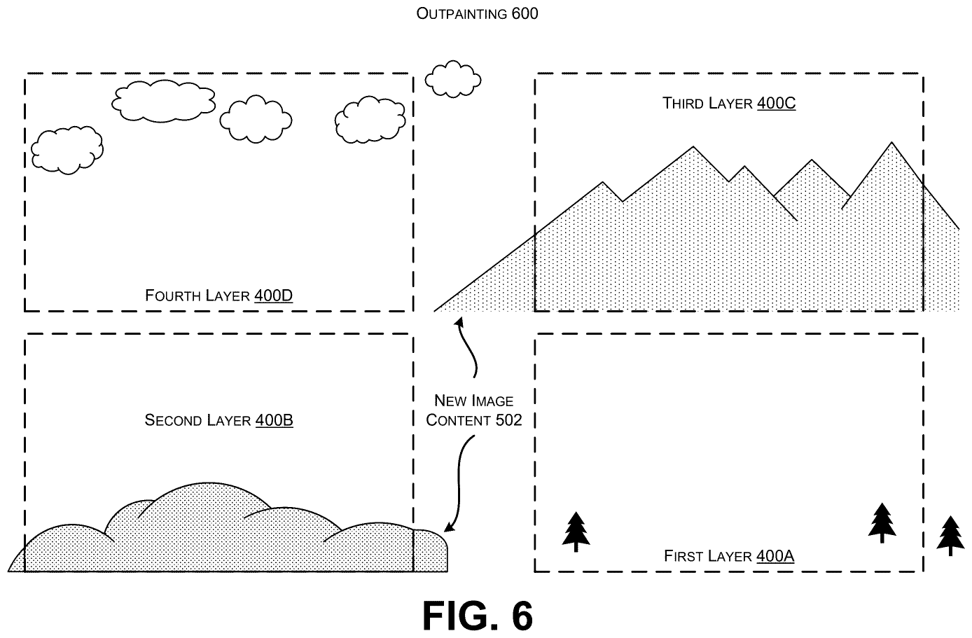

FIG. 6 illustrates a different type of image completion—outpainting 600. Outpainting is an image completion technique that extends the boundaries of an image by generating new content beyond its original edges. It uses algorithms, often based on deep learning models like GANs or CNNs, to predict and synthesize plausible extensions of the image, ensuring the new regions blend seamlessly with the existing content. Illustrative results of outpainting 600 in this example are an additional tree for the first layer 400A, horizontal extension of the hills and mountains in the second layer 400B and the third layer 400C, and an additional cloud for the fourth layer 400D. The results of outpainting 600 are indicated as new image content 502. The additional tree and cloud are also new image content 502 but not explicitly labeled as such. Thus, new image content 502 includes image content that was not part of the 2D image 200 and was created by inpainting 500, outpainting 600, or any other image completion technique. After outpainting 600, the layers 400 are extended so that perspectives which look past the edges of the 2D image 200 can be generated.

Any current or later developed technique for outpainting 600 may be used. Many suitable techniques use AI and deep learning. GANs are widely used for outpainting due to their ability to generate realistic extensions of images. The generator creates new content, while the discriminator ensures the generated content blends seamlessly with the existing image. CNNs are employed to predict and synthesize new image regions based on the context provided by the existing image. They are effective in capturing spatial hierarchies and details. Stable diffusion models leverage latent diffusion processes to generate high-quality image extensions. They are particularly useful for creating detailed and coherent outpainted regions. Contextual attention mechanisms focus on relevant parts of the image to guide the generation of new content, ensuring that the outpainted regions are contextually appropriate and visually consistent. Transformers, known for their success in natural language processing, are also applied to image outpainting. They can capture long-range dependencies and generate coherent image extensions.

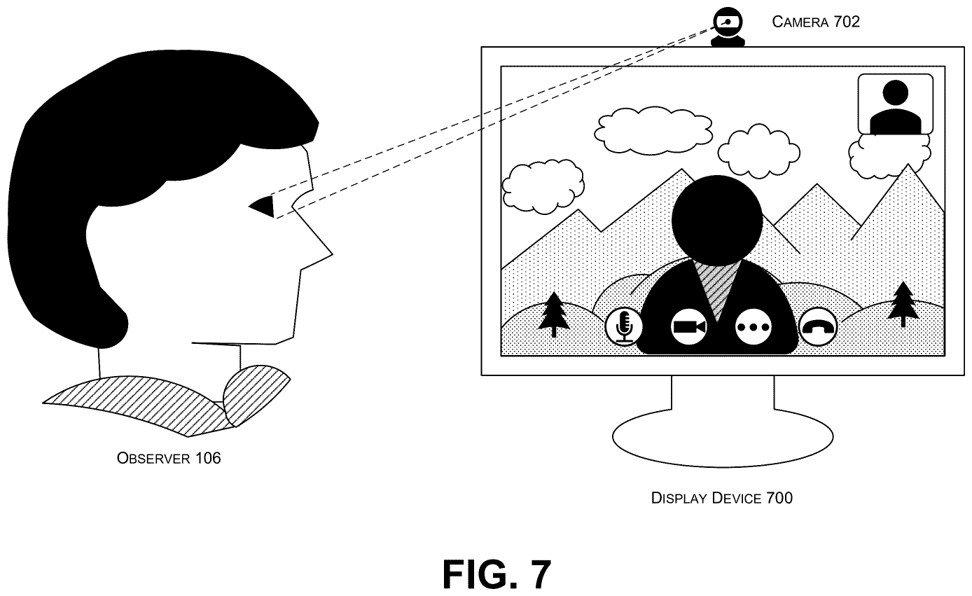

FIG. 7 illustrates viewpoint orientation tracking of an observer 106 viewing a display device 700 displaying a videoconference UI. Viewpoint orientation tracking includes any current or later developed technique for identifying or estimating where the observer 106 is positioned relative to the display device 700 and/or where the observer 106 is looking on the display device 700. Viewpoint orientation tracking refers to the comprehensive process of monitoring and analyzing the direction and position of a user's gaze, head, and body in a given space. This includes eye movement tracking, which measures the direction and focus of a user's eye movements to determine where they are looking, as well as head tracking that involves monitoring the orientation and position of a user's head to understand its movements and direction in space. For example, a camera may detect the position of the observer's 106 head, eye sockets, eye-gazing direction, and/or the like. Then, using a center position of the observer's 106 eye sockets or eyeballs or eye-gazing direction, a computing device may determine an eye gazing direction and angle with respect to the display device 700. Viewpoint orientation tracking is performed in real time.

Existing platforms for implementing viewpoint orientation tracking include PyGaze, Pupil Labs, and Libretracker. PyGaze is an open-source toolbox for eye tracking in Python. It provides a range of functionalities for administering and analyzing eye-tracking data. PyGaze also includes related projects like PyGaze Analyser and a webcam eye-tracker. Pupil Labs offers an open-source eye tracking platform called Pupil that extensively uses AI. These tools leverage AI for real-time gaze mapping, event annotation, and assistive applications. For example, the Alpha Lab platform integrates generative, preformed transformer (“GPT”) GPT-4V, a large multimodal model, to assist with scene understanding and provide real-time feedback based on eye-tracking data. This platform includes both hardware and software components, with the software written in Python and C++. Libretracker is a free and open-source software for tracking eye movements using webcams. It primarily uses OpenCV for capturing and processing video streams. OpenCV includes various machine learning and computer vision algorithms that can be utilized for tasks such as pupil detection and gaze estimation.

Viewpoint orientation tracking may be performed with specialized hardware such as one or more depth sensing cameras and/or infrared illuminators and infrared cameras that detect things such as the shape of the observer's 106 face, eye socket location and from that identify head orientation and gaze direction. Eye movement tracking may be performed using pupil center and cornea reflection to track eye position.

A camera 702 may be located on, near, or integrated into the display device 700. In an implementation, the camera 702 is a red-green-blue (RGB) camera. Thus, the camera 702 may lack depth sensing functionality. This camera 702 may be located in a same plane as the display device 700 and facing toward a person viewing the display device 700 (e.g., a webcam). This camera 702 may be used for viewpoint orientation tracking. Thus, viewpoint orientation tracking may be performed with an RGB camera. If the camera 702 functions as a webcam, then viewpoint orientation tracking can be performed by the same camera that is used to capture video of the observer 106 for the videoconference. In some implementations, only the camera 702 is used to perform viewpoint orientation tracking without any other cameras or specialized hardware.

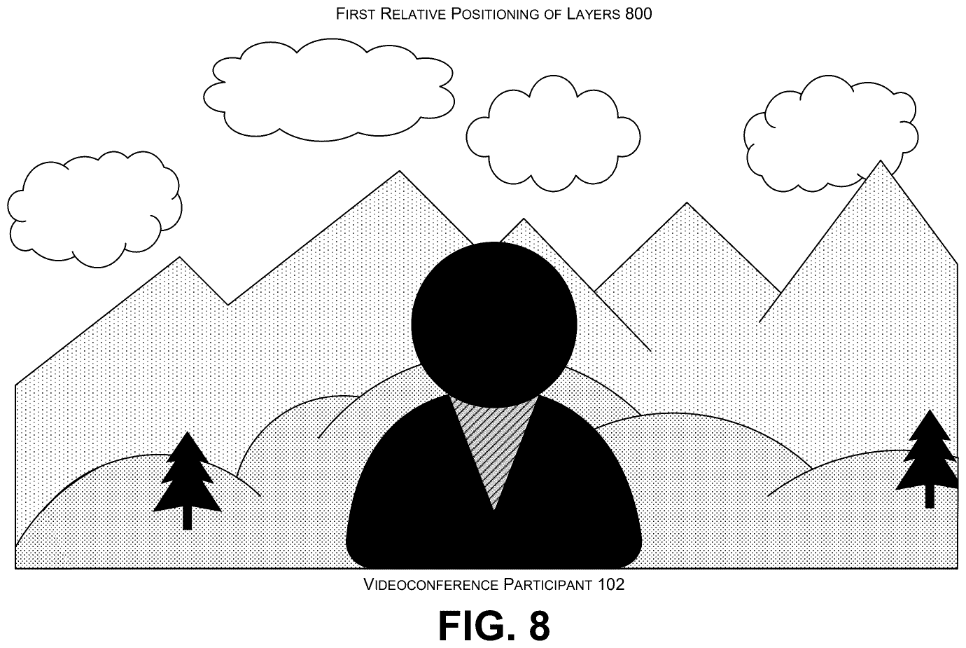

FIG. 8 illustrates a first relative positioning of layers 800 of a background. This is an example appearance of the background 104 of the videoconference UI 100 shown in FIG. 1. The relative positioning of the layers that make up the background is based on the viewpoint orientation of the observer.

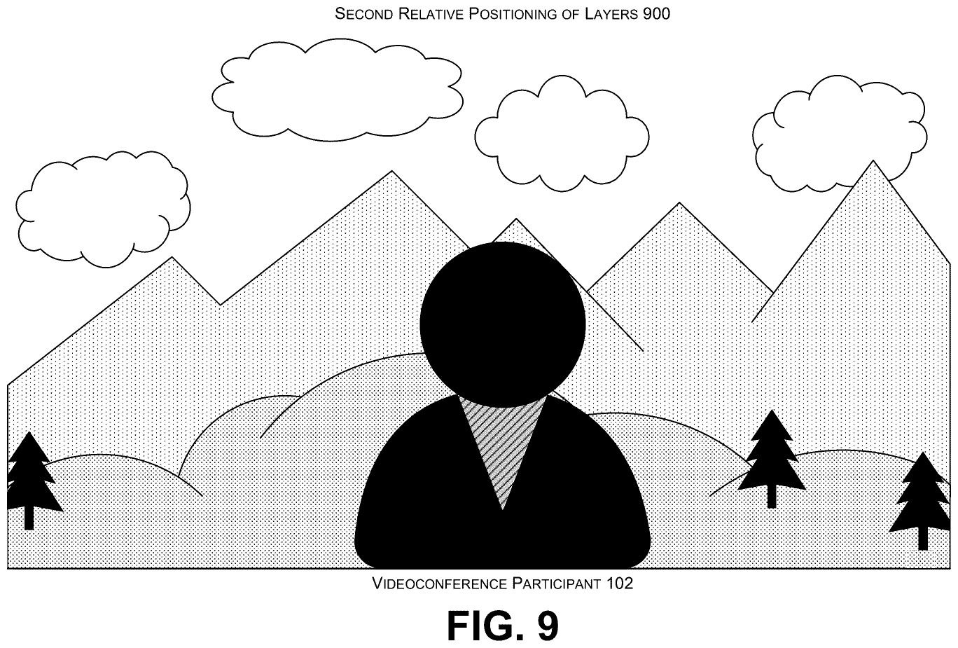

FIG. 9 illustrates a second relative positioning of layers 900 of the background. Only two different relative positioning of layers are shown, but it is to be understood that the positioning of layers will be recalculated and adjusted in real-time thousands of times during a videoconference. Due to a change in the viewpoint orientation of the observer, the positions of the layers have shifted relative to each other. This results in a different appearance of the background than is shown in FIG. 8. As the observer's head position and/or direction of gaze changes the position of the layers can shift in both vertical and horizontal directions. Movement according to the parallax effect creates the illusion of depth in the background. The position of the videoconference participant 102 does not change in response to movement of the observer. The layers may shift so that the relative positioning of the layers results in display of a portion of a layer that was not in the 2D image and was generated by image completion. For example, the right-most tree in FIG. 9 is an object that was created by outfill and becomes visible on the UI in the second relative positioning of layers 900.

The parallax effect is an apparent shift in the position of an object when viewed from different perspectives. This phenomenon occurs because of the change in the observer's viewpoint. In computer graphics, the parallax effect is used to create an illusion of depth and three-dimensionality in 2D images. The parallax effect helps simulate depth by making background elements move differently compared to foreground elements. In simulating the parallax effect, objects closer to the front of the image move faster than those farther away. This mimics how human eyes perceive depth in the real world. Thus, in this example, for a given amount of change in the viewpoint of the observer, the trees in the foreground move a greater distance on the screen than the clouds in the background. The immersive background enables dynamic 3D effects from 2D images and uses real-time eye tracking for interactive background adjustment, which creates an immersive parallax effect, enhancing user engagement and a more natural videoconferencing experience.

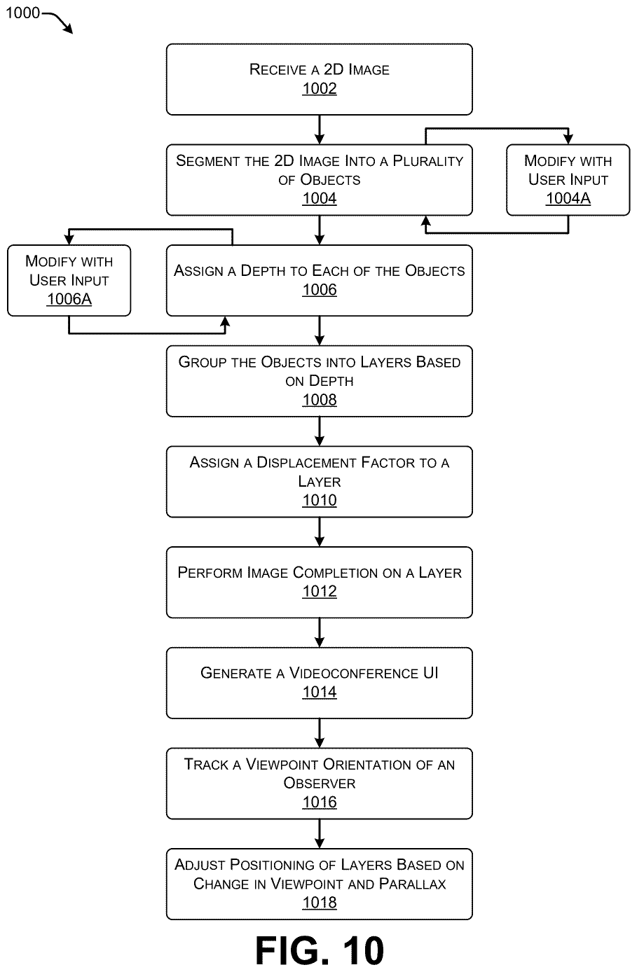

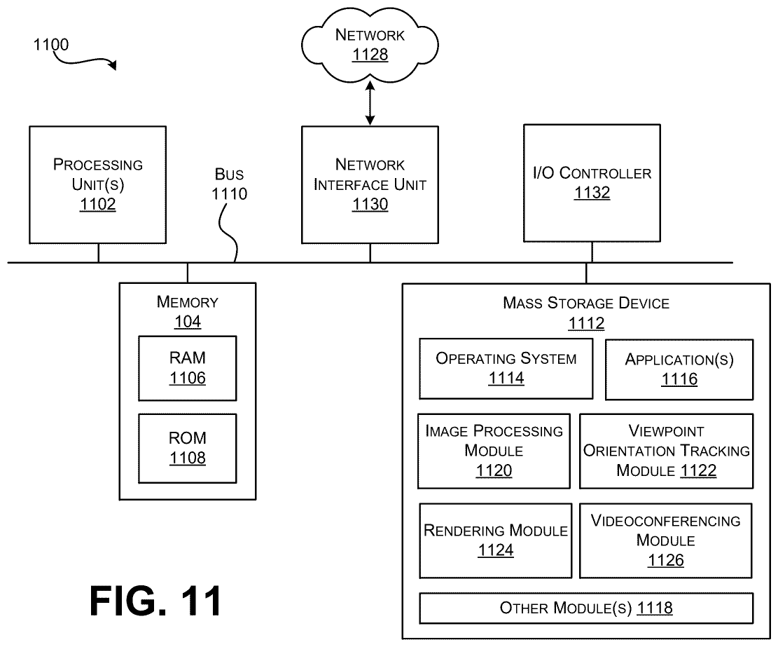

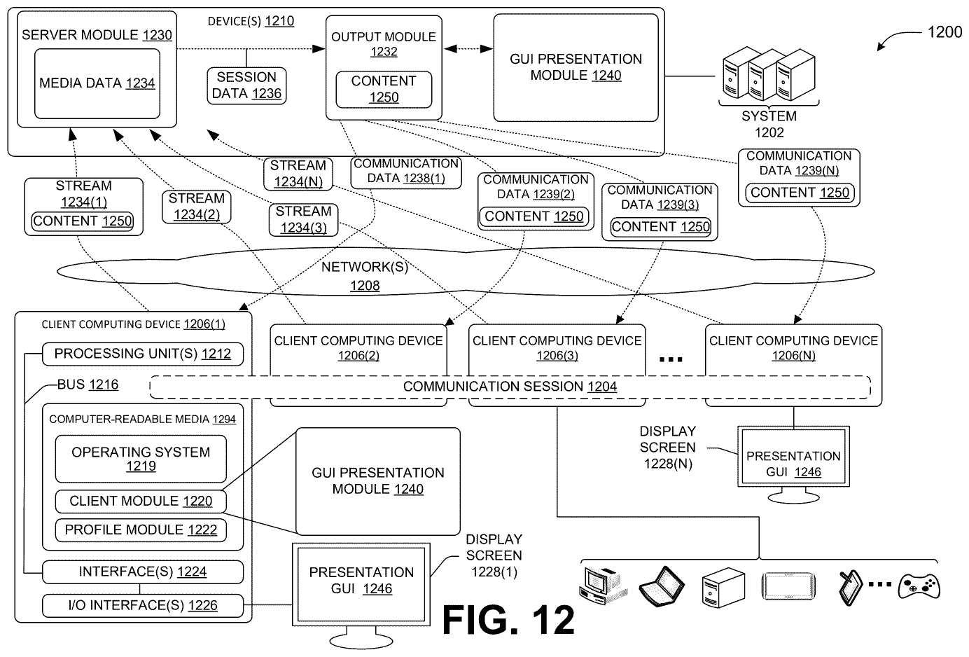

FIG. 10 is a flowchart of an illustrative process 1000 for generating and using an immersive background. The background may be used in a videoconference but is not limited to only videoconference applications. Process 1000 may be used to implement the UI's and image processing illustrated in FIGS. 1-9. Process 1000 may be implemented by the computing device of FIG. 11 and/or the environment of FIG. 12.

At operation 1002, a 2D image is received. The 2D image may be any type of image in any type of computer-file format. The 2D image may be uploaded to a system or received through an image selection user interface.

At operation 1004, the 2D image is segmented into a plurality of objects. Segmenting the 2D image can be performed by a segmentation model. The segmentation model may be created at least in part by machine learning. One example of a segmentation model is Segment Anything.

At operation 1004A, the segmentation of the objects may be modified in response to user input. If for example, the segmentation model did not accurately distinguish objects or segment the 2D image, a user may provide manual adjustments and corrections. However, this operation may be bypassed in fully automated processes.

At operation 1006, a depth is assigned to each of the objects. The assigned depth may be represented by a depth value. The depth is relative to other objects in the 2D image and may also be relative to the image of the videoconference participant. If the image is a photograph, the depth represents the distance of the actual object from the camera that created the 2D image. The depth is assigned by a depth estimation model. This may be a monocular depth estimation model. The depth estimation model can be created at least in part by machine learning. Examples of depth estimation models include Depth Anything and Marigold.

At operation 1006A, the depth assigned to an object or layer may be modified in response to user input. If for example, the automated techniques did not accurately determine the depth of an object or layer, a user may provide manual adjustments and corrections. However, this operation may be bypassed in fully automated processes.

At operation 1008, the objects are grouped into a plurality of layers based on depth. Any suitable technique may be used for sorting, grouping, or clustering the objects into a discrete number of 2D layers. All objects determined to have the same or similar depth are grouped into a same layer and then all image content in that layer is assigned the same depth. The plurality of layers includes at least two layers but there is no upper limit on the number of layers. The depth for a layer is based on the depths of the objects included in that layer. If a layer contains multiple objects with different depths, there are several ways to assign a single depth to that layer. The layer's depth could be calculated as the average or median of all object depths within it, or it could be set to the maximum or minimum depth among its objects. Other calculation methods are also possible for assigning a depth value to a layer.

At operation 1010, a displacement factor is assigned to a layer. The displacement factor is based on the depth value of the layer. The displacement factor is a scaling coefficient that determines how much a layer moves relative to other layers when creating parallax effects. It can be thought of as the “speed” at which a layer moves in response to viewpoint changes. It is typically calculated as a function of the layer's depth and a base parallax coefficient, with shallower layers experiencing greater displacement than deeper ones when the viewpoint orientation of an observer changes. Thus, the displacement factor will be higher for layers closer to the front of the scene and lower for more distant layers. A very distant layer that does not move can have a displacement factor of zero.

At operation 1012, image completion is performed on a layer. Image completion includes any technique for completing or adding to image content in the 2D image. Image completion adds to a layer new image content that is not in the 2D image. Thus, image completion generates new pixels and adds them to a layer. Image completion may be performed by an image inpainting model and/or an image outpainting model. There are many known types of inpainting and outpainting models that may be used including models created at least in part by machine learning.

At operation 1014, a videoconference UI is generated. The videoconference UI shows a video stream of a videoconference participant in front of the immersive background made up of the plurality of layers. The videoconference UI may include any other UI elements that can be found in a videoconference. The videoconference UI is typically displaced on a display device viewed by an observer.

At operation 1016, a viewpoint orientation of the observer of the videoconference UI is tracked. Viewpoint orientation tracking includes eye movement tracking, gaze tracking, and head position tracking. Specialized hardware such as depth or infrared cameras may be used to track movement of the observer's head, face, and/or eyes. Additionally or alternatively, a conventional RGB camera such as a webcam may be used for viewpoint orientation tracking. In some implementations, only a RGB webcam is used for viewpoint orientation tracking and no additional hardware is used. Thus, tracking the viewpoint orientation of the observer may be performed by a single camera directed towards a face of the observer and positioned in the same plane as a display device displaying the videoconference UI (e.g., a webcam).

At operation 1018, positioning of layers is adjusted based on change in the viewpoint of the observer and the parallax effect. As the observer's perspective shifts, each layer's x and y coordinates are updated according to its assigned depth value, with closer layers exhibiting greater displacement than distant ones. This differential movement creates a convincing illusion of three-dimensional space behind the videoconference participant. A rendering engine, or similar, processes these position updates in real-time using observer head tracking and/or eye tracking data, and include smooth transitions between frames to provide a natural viewing experience.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 1000 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the process 1000 may be also implemented in many other ways. For example, the process 1000 may be implemented, at least in part, by a processor of another remote computer or a local circuit. In addition, one or more of the operations of the process 1000 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

### Illustrative Computing Device and Environment

FIG. 11 shows details of an example computer architecture 1100 for a device, such as a computer or a server configured as part of the systems described herein, capable of executing computer instructions (e.g., a module or a program component described herein). The computer architecture 1100 illustrated in FIG. 11 includes processing unit(s) 1102, a memory 1104, including a random-access memory 1106 (“RAM”) and a read-only memory (“ROM”) 1108, and a system bus 1110 that couples the memory 1104 to the processing unit(s) 1102.

Processing unit(s), such as processing unit(s) 1102, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 1100, such as during startup, is stored in the ROM 1108. The computer architecture 1100 further includes a mass storage device 1112 for storing an operating system 1114, application(s) 1116, other modules 1118, and other data described herein. The modules are implemented by instructions stored in computer-readable storage medium and executed by the processing unit(s) 1102.

An image processing module 1120 is configured to convert a 2D image into a 2.5D image comprising a plurality of layers as described above. The image processing module 1120 may use machine learning and AI to process the 2D image. The image processing module 1120 performs image segmentation and object identification on the 2D image. Image segmentation segments the 2D image into a plurality of objects. The image processing module 1120 also performs depth estimation such as by use of monocular depth estimation algorithms to determine relative depths of objects in the 2D image and assign a depth value to each of the plurality of objects. The image processing module 1120 creates a plurality of layers from the 2D image that each have a single depth value. It may do this by grouping the plurality of objects into the plurality of layers based on the depth assigned to each object. The image processing module 1120 also performs image completion which includes inpainting and outpainting to add new image content to a layer of the plurality of layers. The image processing module 1120 may process a 2D image through a fully automated pipeline with no user input. However, it may also adjust a segmentation of the 2D image created by a segmentation model in response to user input or adjust a depth assigned to one of the plurality of objects by a depth estimation model in response to user input.

A viewpoint orientation tracking module 1122 is configured to track the viewpoint orientation of an observer of a videoconference UI in real time. The observer may also be a participant in the videoconference. The viewpoint orientation tracking module 1122 uses head tracking, gaze tracking, and/or eye tracking to determine the position of the observer's head in space and where the observer is looking on a displace device. The viewpoint orientation tracking module 1122 can receive data from various types of hardware, including RGB cameras, infrared cameras, and depth sensing cameras, to capture detailed information about the observer's head and eye movements. In an implementation, the viewpoint orientation tracking module tracks the viewpoint orientation of the observer using input from a camera directed towards a face of the observer and positioned in the same plane as a display device displaying the 2.5D image. By analyzing this data, the viewpoint orientation tracking module 1122 can identify real-time changes in the observer's gaze direction and head orientation. Additionally, the viewpoint orientation tracking module 1122 may use AI based techniques and systems.

A rendering module 1124 is configured to render the 2.5D image and adjust a relative positioning of the plurality of layers based on a change in the viewpoint orientation of the observer and the parallax effect. The change in the viewpoint orientation of the observer is provided by the viewpoint orientation tracking module 1122. This creates the illusion of depth in the background because shallower layers move faster than deeper layers.

The rendering module 1124 processes input data from the viewpoint orientation tracking module 1122 to calculate displacement vectors for each layer in the 2.5D image. As described above, each layer is assigned a depth value corresponding to its calculated depth. These depth values are utilized by the rendering module 1124 to compute proportional displacement magnitudes, with layers assigned lesser depth values exhibiting greater movement in response to viewpoint changes.

The displacement calculations performed by rendering module 1124 can incorporate both linear and non-linear components to achieve realistic parallax motion. For each layer i, rendering module 1124 may compute a displacement factor Dᵢ according to the formula Dᵢ=B*(1−Zᵢ/Zₘₐₓ), where B represents a base parallax coefficient, Zᵢ represents the depth value of layer i, and Zₘₐₓ represents the maximum depth value in the scene. This displacement factor is then applied directly to the x and y coordinates of each layer, with larger displacement factors producing greater movement. As a result, layers closer to the viewer (smaller Zᵢ) receive larger displacement factors and move more, while distant layers (larger Zᵢ) receive smaller displacement factors and move less. The final magnitude of movement is further scaled according to the observer's viewing angle and distance from the display surface.

The rendering module 1124 can also implement temporal smoothing algorithms to ensure fluid motion between successive frames. These algorithms incorporate acceleration limits and motion damping to prevent visual artifacts that might otherwise arise from rapid viewpoint changes. Additionally, the rendering module 1124 may employ predictive motion calculation to compensate for system latency, thereby maintaining the illusion of depth even during dynamic viewing conditions.

To maintain visual coherence, the rendering module 1124 can manage layer intersections and boundaries through an occlusion handling system. This system ensures that the relative positions of layers remain consistent with their assigned depth values, preventing visual anomalies that could compromise the three-dimensional effect. The module also implements a dynamic resolution adjustment system that optimizes rendering performance while maintaining visual quality during rapid viewpoint changes.

The rendering module 1124 may also incorporate a calibration subsystem that automatically adjusts parallax sensitivity based on the observer's distance from the display and the physical dimensions of the display device. This adaptive behavior ensures consistent depth perception across different viewing configurations and display sizes.

A videoconferencing module 1126 implements a videoconference between two or more participants. The videoconferencing module 1126 manages real-time audio and video streams, coordinating their synchronization and transmission across the network while adapting to varying bandwidth conditions. The videoconferencing module 1126 handles participant management, including features such as participant authentication, role assignments, and dynamic joining or leaving of sessions. The videoconferencing module 1126 incorporates audio mixing capabilities to combine multiple audio streams, implements acoustic echo cancellation, and applies noise reduction algorithms to enhance audio quality. For video processing, the videoconferencing module 1126 manages camera inputs, applies video compression codecs, and coordinates screen sharing functionality. The videoconferencing module 1126 processes participant video streams to enable artificial background effects, using computer vision algorithms to detect and segment human figures from their surroundings, then compositing them over user-selected static images or video backgrounds in real time. The videoconferencing module 1126 is configured to superimpose a video stream showing a videoconference participant in front of the 2.5D image thereby creating the immersive background. The videoconferencing module 1126 also implements various collaboration features, including chat messaging, file sharing, and meeting recording capabilities, while maintaining end-to-end encryption for secure communication.

The use of 2.5D images for immersive backgrounds in videoconferencing offers several technical benefits, including reduced processor usage, lower storage requirements, decreased network bandwidth consumption, enhanced user experience, and improved scalability and flexibility. Each of these technical benefits are explained in greater detail below. Creating a full 3D model of a background image requires significant computational power. This involves rendering complex geometries, textures, and lighting effects in real-time, which can be very demanding on processing unit(s) 1102. By using a 2.5D image, the system simplifies these tasks resulting in greatly reduced processing unit(s) 1102 usage. The viewpoint orientation tracking technology and use of the parallax effect allow the system to create the illusion of depth without the need for full 3D rendering. This means the processing unit(s) 1102 have more capacity to handle other tasks, leading to smoother performance during videoconferences.

Full 3D models are typically large files that require substantial storage space. They include detailed information about the geometry, textures, and lighting of the scene. In contrast, 2.5D images are essentially enhanced 2D images with depth information added. These files are much smaller and easier to store. This reduction in storage requirements is particularly beneficial for devices with limited storage capacity, such as smartphones and tablets.

Transmitting full 3D models over a network can consume a lot of bandwidth due to the large file sizes and the need for continuous updates as the viewpoint changes. This can lead to latency issues and degraded video quality, especially in environments with limited bandwidth. By using 2.5D images, the system significantly reduces the amount of data that needs to be transmitted. The viewpoint orientation tracking and parallax effect allow for dynamic adjustments without the need for large data transfers, resulting in a more stable and high-quality videoconferencing experience.

The interactive background adjustments made possible by viewpoint orientation tracking and the parallax effect create a more immersive and engaging videoconferencing experience. Users feel as though they are in a 3D environment, even though the background is created from a stack of 2D images. This can make virtual meetings feel more natural and less fatiguing, improving overall user experience. The modular design, which can include a user interface for selecting images, an image processing module 1120, a viewpoint orientation tracking module 1122, and a rendering module 1124, allows for easy scalability and flexibility. New features and improvements can be added to individual modules without redesigning the entire system. This modularity also makes it easier to integrate the system with various existing videoconferencing platforms and devices.

The mass storage device 1112 is connected to processing unit(s) 1102 through a mass storage controller connected to the bus 1110. The mass storage device 1112 and its associated computer-readable media provide non-volatile storage for the computer architecture 1100. Although the description of computer-readable media contained herein refers to a mass storage device, it should be appreciated by those skilled in the art that computer-readable media can be any available computer-readable storage media or communication media that can be accessed by the computer architecture 1100.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 1100 may operate in a networked environment using logical connections to remote computers through the network 1128. The computer architecture 1100 may connect to the network 1128 through a network interface unit 1130 connected to the bus 1110. The computer architecture 1100 also may include an input/output controller 1132 for receiving and processing input from a number of other devices, including a keyboard, mouse, touch panel, video camera, electronic stylus or pen. Similarly, the input/output controller 1132 may provide output to a display screen, a printer, or other type of output device.

It should be appreciated that the software components described herein may, when loaded into the processing unit(s) 1102 and executed, transform the processing unit(s) 1102 and the overall computer architecture 1100 from a general-purpose computing system into a special-purpose computing system customized to facilitate the functionality presented herein. The processing unit(s) 1102 may be constructed from any number of transistors or other discrete circuit elements, which may individually or collectively assume any number of states. More specifically, the processing unit(s) 1102 may operate as a finite-state machine, in response to executable instructions contained within the software modules disclosed herein. These computer-executable instructions may transform the processing unit(s) 1102 by specifying how the processing unit(s) 1102 transition between states, thereby transforming the transistors or other discrete hardware elements constituting the processing unit(s) 1102.

FIG. 12 is a diagram illustrating an example environment 1200 in which a system 1202 can operate to generate a 2.5D image and use it as an immersive background for a videoconference. In some implementations, a system implemented agent may function to collect and/or analyze data associated with the example environment 1200. For example, the agent may function to collect and/or analyze data exchanged between participants involved in a communication session 1204 linked to the graphical user interfaces (“GUIs”) disclosed herein. As used herein, communication sessions1204 includes videoconference.

As illustrated, the communication session 1204 may be implemented between a number of client computing devices 1206(1) through 1206(N) (where N is a positive integer number having a value of two or greater) that are associated with the system 1202 or are part of the system 1202. The client computing devices 1206(1) through 1206(N) enable users, also referred to as individuals, to participate in the communication session 1204.

In this example, the communication session 1204 is hosted, over one or more network(s) 1208, by the system 1202. That is, the system 1202 can provide a service that enables users of the client computing devices 1206(1) through 1206(N) to participate in the communication session 1204 (e.g., via a live viewing and/or a recorded viewing). Consequently, a “participant” to the communication session 1204 can comprise a user and/or a client computing device (e.g., multiple users may be in a communication room participating in a communication session via the use of a single client computing device), each of which can communicate with other participants. As an alternative, the communication session 1204 can be hosted by one of the client computing devices 1206(1) through 1206(N) utilizing peer-to-peer technologies. The system 1202 can also host chat conversations and other team collaboration functionality (e.g., as part of an application suite).

In some implementations, such chat conversations and other team collaboration functionality are considered external communication sessions distinct from the communication session 1204. A computerized agent to collect participant data in the communication session 1204 may be able to link to such external communication sessions. Therefore, the computerized agent may receive information, such as date, time, session particulars, and the like, that enables connectivity to such external communication sessions. In one example, a chat conversation can be conducted in accordance with the communication session 1204. Additionally, the system 1202 may host the communication session 1204, which includes at least a plurality of participants co-located at a meeting location, such as a meeting room or auditorium, or located in disparate locations.

In examples described herein, client computing devices 1206(1) through 1206(N) participating in the communication session 1204 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds may comprise such audio and visual data, one or more still images, and/or one or more avatars. The one or more still images may also comprise one or more avatars.

Another example of an individual stream of live or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live or recorded content within the communication data enable a remote meeting to be facilitated between a group of people and the sharing of content within the group of people. In some implementations, the various streams of live or recorded content within the communication data may originate from a plurality of co-located video cameras, positioned in a space, such as a room, to record or stream live a presentation that includes one or more individuals presenting and one or more individuals consuming presented content.

A participant or attendee can view content of the communication session 1204 live as activity occurs, or alternatively, via a recording at a later time after the activity occurs. In examples described herein, client computing devices 1206(1) through 1206(N) participating in the communication session 1204 are configured to receive and render for display, on a user interface of a display screen, communication data. The communication data can comprise a collection of various instances, or streams, of live and/or recorded content. For example, an individual stream of content can comprise media data associated with a video feed (e.g., audio and visual data that capture the appearance and speech of a user participating in the communication session). Another example of an individual stream of content can comprise media data that includes an avatar of a user participating in the conference session along with audio data that captures the speech of the user. Yet another example of an individual stream of content can comprise media data that includes a content item displayed on a display screen and/or audio data that captures the speech of a user. Accordingly, the various streams of content within the communication data enable a meeting or a broadcast presentation to be facilitated amongst a group of people dispersed across remote locations.

A participant or attendee to a communication session is a person that is in range of a camera, or other image and/or audio capture device such that actions and/or sounds of the person which are produced while the person is viewing and/or listening to the content being shared via the communication session can be captured (e.g., recorded). For instance, a participant may be sitting in a crowd viewing the shared content live at a broadcast location where a stage presentation occurs. Or a participant may be sitting in an office conference room viewing the shared content of a communication session with other colleagues via a display screen. Even further, a participant may be sitting or standing in front of a personal device (e.g., tablet, smartphone, computer, etc.) viewing the shared content of a communication session alone in their office or at home.

The system 1202 includes device(s) 1210. The device(s) 1210 and/or other components of the system 1202 can include distributed computing resources that communicate with one another and/or with the client computing devices 1206(1) through 1206(N) via the one or more network(s) 1208. In some examples, the system 1202 may be an independent system that is tasked with managing aspects of one or more communication sessions such as communication session 1204. As an example, the system 1202 may be managed by entities such as TEAMS, SLACK, WEBEX, GOTOMEETING, GOOGLE HANGOUTS, etc.

Network(s) 1208 may include, for example, public networks such as the Internet, private networks such as an institutional and/or personal intranet, or some combination of private and public networks. Network(s) 1208 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 1208 may utilize communications protocols, including packet-based and/or datagram-based protocols such as Internet protocol (“IP”), transmission control protocol (“TCP”), user datagram protocol (“UDP”), or other types of protocols. Moreover, network(s) 1208 may also include a number of devices that facilitate network communications and/or form a hardware basis for the networks, such as switches, routers, gateways, access points, firewalls, base stations, repeaters, backbone devices, and the like.

In some examples, network(s) 1208 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 1202.11 standards (e.g., 1202.11g, 1202.11n, 1202.11ac and so forth), and other standards.

In various examples, device(s) 1210 may include one or more computing devices that operate in a cluster or other grouped configuration to share resources, balance load, increase performance, provide fail-over support or redundancy, or for other purposes. For instance, device(s) 1210 may belong to a variety of classes of devices such as traditional server-type devices, desktop computer-type devices, and/or mobile-type devices. Thus, although illustrated as a single type of device or a server-type device, device(s) 1210 may include a diverse variety of device types and are not limited to a particular type of device. Device(s) 1210 may represent, but are not limited to, server computers, desktop computers, web-server computers, personal computers, mobile computers, laptop computers, tablet computers, or any other sort of computing device.

A client computing device (e.g., one of client computing device(s) 1206(1) through 1206(N)) may belong to a variety of classes of devices, which may be the same as, or different from, device(s) 1210, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 1206(1) through 1206(N) of the various classes and device types can represent any type of computing device having one or more data processing unit(s) 1212 operably connected to computer-readable media 1294 such as via a bus 1216, which in some instances can include one or more of a system bus, a data bus, an address bus, a PCI bus, a Mini-PCI bus, and any variety of local, peripheral, and/or independent buses.

Executable instructions stored on computer-readable media 1294 may include, for example, an operating system 1219, a client module 1220, a profile module 1222, and other modules, programs, or applications that are loadable and executable by data processing units(s) 1212.

Client computing device(s) 1206(1) through 1206(N) may also include one or more interface(s) 1224 to enable communications between client computing device(s) 1206(1) through 1206(N) and other networked devices, such as device(s) 1210, over network(s) 1208. Such interface(s) 1224 may include one or more network interface controllers (NICs) or other types of transceiver devices to send and receive communications and/or data over a network. Moreover, client computing device(s) 1206(1) through 1206(N) can include input/output (“I/O”) interfaces 1226 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 12 illustrates that client computing device 1206(1) is in some way connected to a display device (e.g., a display screen 1228(1)), which can display a GUI according to the techniques described herein. The display device 700 shown in FIG. 7 is one example of a display screen 1228.

In the example environment 1200 of FIG. 12, client computing devices 1206(1) through 1206(N) may use their respective client modules 1220 to connect with one another and/or other external device(s) in order to participate in the communication session 1204, or in order to contribute activity to a collaboration environment. For instance, a first user may utilize a client computing device 1206(1) to communicate with a second user of another client computing device 1206(2). When executing client modules 1220, the users may share data, which may cause the client computing device 1206(1) to connect to the system 1202 and/or the other client computing devices 1206(2) through 1206(N) over the network(s) 1208.

The client computing device(s) 1206(1) through 1206(N) may use their respective profile module 1222 to generate participant profiles (not shown in FIG. 12) and provide the participant profiles to other client computing devices and/or to the device(s) 1210 of the system 1202. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 12, the device(s) 1210 of the system 1202 includes a server module 1230 and an output module 1232. In this example, the server module 1230 is configured to receive, from individual client computing devices such as client computing devices 1206(1) through 1206(N), media streams 1234(1) through 1234(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 1230 is configured to receive a collection of various media streams 1234(1) through 1234(N) during a live viewing of the communication session 1204 (the collection being referred to herein as “media data 1234”). In some scenarios, not all the client computing devices that participate in the communication session 1204 provide a media stream. For example, a client computing device may only be a consuming, or a “listening”, device such that it only receives content associated with the communication session 1204 but does not provide any content to the communication session 1204.

In various examples, the server module 1230 can select aspects of the media streams 1234 that are to be shared with individual ones of the participating client computing devices 1206(1) through 1206(N). Consequently, the server module 1230 may be configured to generate session data 1236 based on the streams 1234 and/or pass the session data 1236 to the output module 1232. Then, the output module 1232 may communicate communication data 1238 to the client computing devices (e.g., client computing devices 1206(1) through 1206(3) participating in a live viewing of the communication session). The communication data 1238 may include video, audio, and/or other content data, provided by the output module 1232 based on content 1250 associated with the output module 1232 and based on received session data 1236.

As shown, the output module 1232 transmits communication data 1238(1) to client computing device 1206(1), and transmits communication data 1238(2) to client computing device 1206(2), and transmits communication data 1238(3) to client computing device 1206(3), etc. The communication data 1238 transmitted to the client computing devices can be the same or can be different (e.g., positioning of streams of content within a user interface may vary from one device to the next).

In various implementations, the device(s) 1210 and/or the client module 1220 can include GUI presentation module 1240. The GUI presentation module 1240 may be configured to analyze communication data 1238 that is for delivery to one or more of the client computing devices 1206. Specifically, the GUI presentation module 1240, at the device(s) 1210 and/or the client computing device 1206, may analyze communication data 1238 to determine an appropriate manner for displaying video, image, and/or content on the display screen 1228 of an associated client computing device 1206. In some implementations, the GUI presentation module 1240 may provide video, image, and/or content to a presentation GUI 1246 rendered on the display screen 1228 of the associated client computing device 1206. The presentation GUI 1246 may be caused to be rendered on the display screen 1228 by the GUI presentation module 1240. The presentation GUI 1246 may include the video, image, and/or content analyzed by the GUI presentation module 1240.

In some implementations, the presentation GUI 1246 may include a plurality of sections or grids that may render or comprise video, image, and/or content for display on the display screen 1228. For example, a first section of the presentation GUI 1246 may include a video feed of a videoconference participant, a second section of the presentation GUI 1246 may include a video feed of an individual consuming meeting information provided by the presenter or individual such as an observer. The GUI presentation module 1240 may populate the first and second sections of the presentation GUI 1246 in a manner that properly imitates an environment experience that the presenter and the individual may be sharing.

In some implementations, the GUI presentation module 1240 may enlarge or provide a zoomed view of the individual represented by the video feed in order to highlight a reaction, such as a facial feature, the individual had to the presenter. In some implementations, the presentation GUI 1246 may include a video feed of a plurality of participants associated with a meeting, such as a general communication session. In other implementations, the presentation GUI 1246 may be associated with a channel, such as a chat channel, enterprise TEAMS channel, or the like. Therefore, the presentation GUI 1246 may be associated with an external communication session that is different than the general communication session.

### Illustrative Embodiments

The following clauses described multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Clause 1. A method of generating an immersive background (104) comprising: receiving a two-dimensional (2D) image (200); segmenting the 2D image into a plurality of objects (300); assigning a depth to each of the plurality of objects; grouping the plurality of objects into a plurality of layers (400) based on depth; performing image completion (500, 600) on a layer of the plurality of layers to add to the layer new image content (502) that is not in the 2D image; generating a videoconference user interface (UI) (100) showing a videoconference participant (102) in front of the immersive background comprising the plurality of layers; tracking a viewpoint orientation of an observer (106) of the videoconference UI; and adjusting a relative positioning of the plurality of layers based on a change in the viewpoint orientation of the observer and the parallax effect.

Clause 2. The method of clause 1, wherein segmenting the 2D image is performed by a segmentation model created at least in part by machine learning.

Clause 3. The method of clause 2, further comprising modifying segmentation of the 2D image performed by the segmentation model in response to user input.

Clause 4. The method of any of clauses 1-3, wherein assigning the depth to each of the plurality of objects is performed by a depth estimation model created at least in part by machine learning.

Clause 5. The method of clause 4, further comprising modifying the depth of at least one of the plurality of objects or plurality of layers as assigned by the depth estimation model in response to user input.

Clause 6. The method of any of clauses 1-5, wherein the image completion is performed by at least one of an image inpainting model or an image outpainting model created at least in part by machine learning.

Clause 7. The method of any of clauses 1-6, wherein tracking the viewpoint orientation of the observer is performed by a single camera directed towards a face of the observer and positioned in the same plane as a display device displaying the videoconference UI.

Clause 8. The method of any of clauses 1-7, further comprising assigning a displacement factor to a layer of the plurality of layers based on a depth value of the layer.

Clause 9. A system comprising: a processing unit (1102); a computer-readable storage medium (1112); an image processing module (1120), implemented by instructions stored in the computer-readable storage medium and executed by the processing unit, configured to convert a two-dimensional (2D) image into a 2.5D image comprising a plurality of layers; a viewpoint orientation tracking module (1122), implemented by instructions stored in the computer-readable storage medium and executed by the processing unit, configured to track the viewpoint orientation of an observer in real time; and a rendering module (1124), implemented by instructions stored in the computer-readable storage medium and executed by the processing unit, configured to render the 2.5D image and adjust a relative positioning of the plurality of layers based on a change in the viewpoint orientation of the observer and the parallax effect.

Clause 10. The system of clause 9, wherein the image processing module is configured to segment the 2D image into a plurality of objects.

Clause 11. The system of clause 10, wherein the image processing module is configured to assign a depth to each of the plurality of objects.

Clause 12. The system of clause 11, wherein the image processing module is configured to group the plurality of objects into the plurality of layers based on the depth assigned to each object.

Clause 13. The system of clause 12, wherein the image processing module is configured to add new image content to a layer of the plurality of layers by image completion.

Clause 14. The system of any of clauses 9-13, wherein the image processing module is configured to (i) adjust a segmentation of the 2D image created by a segmentation model in response to user input or (ii) adjust a depth assigned to one of the plurality of objects by a depth estimation model in response to user input.

Clause 15. The system of any of clauses 9-14, wherein the viewpoint orientation tracking module is configured to track the viewpoint orientation of the observer using input from a camera directed towards a face of the observer and positioned in the same plane as a display device displaying the 2.5D image.

Clause 16. The system of any clauses 9-15, further comprising a videoconferencing module, implemented by instructions stored in the computer-readable storage medium and executed by the processing unit, configured to superimpose a video stream showing a videoconference participant in front of the 2.5D image

Clause 17. A user interface (UI) (100) comprising: an image of a videoconference participant (102); and a background (104) behind the image of the videoconference participant, the background comprising a plurality of layers created from a 2D image by layer segmentation, depth estimation, and image completion, wherein, a relative positioning of the layers with respect to each other shifts based on the parallax effect in response to a change in viewpoint orientation of an observer of the UI.

Clause 18. The UI of clause 17, wherein each layer comprises one or more objects identified by layer segmentation that are determined to have a same depth based on depth estimation.

Clause 19. The UI of clause 17 or 18, wherein a shift in the relative positioning of the layers results in display of a portion of a layer that was not in the 2D image and was generated by image completion.

Clause 20. The UI of any of clauses 17-19, further comprising an image of the observer captured by a camera that is also used for detecting viewpoint orientation of the observer.

Clause 21. A computer-readable storage medium having encoded thereon computer-readable instructions that when executed by a processing unit causes a system to: receive a two-dimensional (2D) image (200); segment the 2D image into a plurality of objects (300); assign a depth to each of the plurality of objects; group the plurality of objects into a plurality of layers (400) based on depth; perform image completion (500, 600) on a layer of the plurality of layers to add to the layer new image content (502) that is not in the 2D image; generate a videoconference user interface (UI) (100) configured to show a videoconference participant (102) in front of the immersive background comprising the plurality of layers; track a viewpoint orientation of an observer (106) of the videoconference UI; and adjust relative positions of the plurality of layers based on a change in the viewpoint orientation of the observer and the parallax effect.

Clause 22. The computer-readable storage medium of clause 21, wherein segmentation of the 2D image is performed by a segmentation model created at least in part by machine learning.

Clause 23. The computer-readable storage medium of clause 22, further comprising instructions to modify segmentation of the 2D image performed by the segmentation model in response to user input.

Clause 24. The computer-readable storage medium of any of clauses 21-23, wherein assignment of the depth to each of the plurality of objects is performed by a depth estimation model created at least in part by machine learning.

Clause 25. The computer-readable storage medium of clause 24, further comprising instructions to modify the depth of at least one of the plurality of objects or plurality of layers as assigned by the depth estimation model in response to user input.

Clause 26. The computer-readable storage medium of any of clauses 21-25, wherein the image completion is performed by at least one of an image inpainting model or an image outpainting model created at least in part by machine learning.

Clause 27. The computer-readable storage medium of any of clauses 21-26, wherein tracking the viewpoint orientation of the observer is performed by a single camera directed towards a face of the observer and positioned in the same plane as a display device displaying the videoconference UI.

Clause 28. The computer-readable storage medium of any of clauses 21-27, further comprising instructions to assign a displacement factor to a layer of the plurality of layers based on a depth value of the layer.

Clause 29. A system comprising: a processing unit (1102); a computer-readable storage medium (1112); a means of image processing (1120) configured to convert a two-dimensional (2D) image into a 2.5D image comprising a plurality of layers; a means for viewpoint orientation tracking (1122) configured to track the viewpoint orientation of an observer in real time; and a means for rendering (1124) configured to render the 2.5D image and adjust a relative positioning of the plurality of layers based on a change in the viewpoint orientation of the observer and the parallax effect.

Clause 30. The system of clause 29, wherein the means for image processing is configured to segment the 2D image into a plurality of objects.

Clause 31. The system of clause 30, wherein the means for image processing is configured to assign a depth to each of the plurality of objects.

Clause 32. The system of clause 31, wherein the means for image processing is configured to group the plurality of objects into the plurality of layers based on the depth assigned to each object.

Clause 33. The system of clause 32, wherein the means for image processing is configured to add new image content to a layer of the plurality of layers by image completion.

Clause 34. The system of any of clauses 29-33, wherein the means for image processing is configured to (i) adjust a segmentation of the 2D image created by a segmentation model in response to user input or (ii) adjust a depth assigned to one of the plurality of objects by a depth estimation model in response to user input.

Clause 35. The system of any of clauses 29-34, wherein the means for viewpoint orientation tracking is configured to track the viewpoint orientation of the observer using input from a camera directed towards a face of the observer and positioned in the same plane as a display device displaying the 2.5D image.

Clause 36. The system of any clauses 29-35, further comprising means for videoconferencing configured to superimpose a video stream showing a videoconference participant in front of the 2.5D image

### Conclusion

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

The terms “a,” “an,” “the” and similar referents used in the context of describing the invention are to be construed to cover both the singular and the plural unless otherwise indicated herein or clearly contradicted by context. The terms “based on,” “based upon,” and similar referents are to be construed as meaning “based at least in part” which includes being “based in part” and “based in whole,” unless otherwise indicated or clearly contradicted by context. The terms “portion,” “part,” or similar referents are to be construed as meaning at least a portion or part of the whole including up to the entire noun referenced. As used herein, “approximately” or “about” or similar referents denote a range of ±10% of the stated value.

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and unless other otherwise contradicted by context any number of the described process blocks may be combined in any order to implement the process or an alternate process. Moreover, it is also possible that one or more of the provided operations is modified or omitted.

Certain embodiments are described herein, including the best mode known to the inventors for carrying out the invention. Of course, variations on these described embodiments will become apparent to those of ordinary skill in the art upon reading the foregoing description. Skilled artisans will know how to employ such variations as appropriate, and the embodiments disclosed herein may be practiced otherwise than specifically described. Accordingly, all modifications and equivalents of the subject matter recited in the claims appended hereto are included within the scope of this disclosure. Moreover, any combination of the above-described elements in all possible variations thereof is encompassed by the invention unless otherwise indicated herein or otherwise clearly contradicted by context.

Furthermore, references may have been made to publications, patents, and/or patent applications throughout this specification. Each of the cited references is individually incorporated herein by reference for its particular cited teachings as well as for all that it discloses.

1. A method of generating an immersive background comprising:
receiving a two-dimensional (2D) image;
segmenting the 2D image into a plurality of objects;
assigning a depth to each of the plurality of objects;
grouping the plurality of objects into a plurality of layers based on depth;
performing image completion on a layer of the plurality of layers to add to the layer new image content that is not in the 2D image;
generating a videoconference user interface (UI) showing a videoconference participant in front of the immersive background comprising the plurality of layers;
tracking a viewpoint orientation of an observer of the videoconference UI; and
adjusting a relative positioning of the plurality of layers based on a change in the viewpoint orientation of the observer and the parallax effect.

2. The method of claim 1, wherein segmenting the 2D image is performed by a segmentation model created at least in part by machine learning.

3. The method of claim 2, further comprising modifying segmentation of the 2D image performed by the segmentation model in response to user input.

4. The method of claim 1, wherein assigning the depth to each of the plurality of objects is performed by a depth estimation model created at least in part by machine learning.

5. The method of claim 4, further comprising modifying the depth of at least one of the plurality of objects or plurality of layers as assigned by the depth estimation model in response to user input.

6. The method of claim 1, wherein the image completion is performed by at least one of an image inpainting model or an image outpainting model created at least in part by machine learning.

7. The method of claim 1, wherein tracking the viewpoint orientation of the observer is performed by a single camera directed towards a face of the observer and positioned in the same plane as a display device displaying the videoconference UI.

8. The method of claim 1, further comprising assigning a displacement factor to a layer of the plurality of layers based on a depth value of the layer.

9. A system comprising:
a processing unit;
a computer-readable storage medium;
an image processing module, implemented by instructions stored in the computer-readable storage medium and executed by the processing unit, configured to convert a two-dimensional (2D) image into a 2.5D image comprising a plurality of layers;
a viewpoint orientation tracking module, implemented by instructions stored in the computer-readable storage medium and executed by the processing unit, configured to track the viewpoint orientation of an observer in real time; and
a rendering module, implemented by instructions stored in the computer-readable storage medium and executed by the processing unit, configured to render the 2.5D image and adjust a relative positioning of the plurality of layers based on a change in the viewpoint orientation of the observer and the parallax effect.

10. The system of claim 9, wherein the image processing module is configured to segment the 2D image into a plurality of objects.

11. The system of claim 10, wherein the image processing module is configured to assign a depth to each of the plurality of objects.

12. The system of claim 11, wherein the image processing module is configured to group the plurality of objects into the plurality of layers based on the depth assigned to each object.

13. The system of claim 12, wherein the image processing module is configured to add new image content to a layer of the plurality of layers by image completion.

14. The system of claim 9, wherein the image processing module is configured to (i) adjust a segmentation of the 2D image created by a segmentation model in response to user input or (ii) adjust a depth assigned to one of the plurality of objects by a depth estimation model in response to user input.

15. The system of claim 9, wherein the viewpoint orientation tracking module is configured to track the viewpoint orientation of the observer using input from a camera directed towards a face of the observer and positioned in the same plane as a display device displaying the 2.5D image.

16. The system of claim 9, further comprising a videoconferencing module, implemented by instructions stored in the computer-readable storage medium and executed by the processing unit, configured to superimpose a video stream showing a videoconference participant in front of the 2.5D image.

17. A user interface (UI) comprising:
an image of a videoconference participant; and
a background behind the image of the videoconference participant, the background comprising a plurality of layers created from a 2D image by layer segmentation, depth estimation, and image completion,
wherein, a relative positioning of the layers with respect to each other shifts based on the parallax effect in response to a change in viewpoint orientation of an observer of the UI.

18. The UI of claim 17, wherein each layer comprises one or more objects identified by layer segmentation that are determined to have a same depth based on depth estimation.

19. The UI of claim 17, wherein a shift in the relative positioning of the layers results in display of a portion of a layer that was not in the 2D image and was generated by image completion.

20. The UI of claim 17, further comprising an image of the observer captured by a camera that is also used for detecting viewpoint orientation of the observer.
